(19) United States
(12) Patent Application Publication
(10) Pub. No.: US 2025/0303539 A1
(43) Pub. Date: Oct. 2, 2025

(54) TOOL FOR ASSEMBLING HOSE AND CONNECTOR

(71) Applicant: Hokchun LUO, Dongguan City (CN)

(72) Inventor: Hokchun LUO, Dongguan City (CN)

(21) Appl. No.: 19/232,896

(22) Filed: Jun. 10, 2025

(51) Int. Cl. B25B 27/14; B25B 5/00; B25B 5/04; B25B 5/10; B25B 5/14; B25B 5/16

(52) U.S. Cl. CPC B25B 27/143; B25B 5/003; B25B 5/006; B25B 5/04; B25B 5/102; B25B 5/109; B25B 5/147; B25B 5/166

(57) ABSTRACT

A tool for assembling a hose and a connector, which includes a base, a hose clamping assembly, a connector clamping assembly and a drive assembly. The base includes an assembly axis α. The hose clamping assembly is slidably connected to the base. The connector clamping assembly is rotatably connected to the base and the drive assembly is configured to drive the connector clamping assembly to rotate about the assembly axis α while moving toward or away from the hose clamping assembly. The drive assembly drives the connector clamping assembly to perform rotational motion about the assembly axis α, while simultaneously moving axially toward or away from the hose clamping assembly, thereby achieving synchronized axial advancement of the connector during rotation. This “rotation +linear feed” compound motion significantly reduces assembly time and is particularly suitable for precision-demanding rapid assembly applications.

### TECHNICAL FIELD

The present disclosure relates to the field of manual mechanical equipment, and in particular, to a tool for assembling a hose and a connector.

### BACKGROUND OF THE INVENTION

With societal advancement, hoses and connectors attached thereto have been widely employed in daily operations. However, establishing secure connections between diverse types of hoses and connectors remains a persistent challenge in the art.

Current auxiliary installation tools predominantly feature non-adjustable connector-retaining mechanisms (e.g., coupling nut receptacles). Due to the absence of unified industry standards, dimensional tolerances vary significantly across connectors from different manufacturers. Consequently, such receptacles are incompatible with nuts from certain brands, thereby limiting such tools' applicability. Moreover, most existing tools lack dedicated hose-clamping assemblies, relying solely on connector-holding structures. This design deficiency not only complicates installation processes but also frequently causes assembly misalignment. Additionally, conventional installers provide no assisted mechanism to advance connectors toward hoses, necessitating manual intervention or secondary tools to complete installations.

Therefore, the present disclosure provides a tool for assembling a hose and a connector, which effectively addresses the aforementioned issues.

### SUMMARY OF THE INVENTION

In order to overcome the shortcomings of the prior art, the present disclosure provides a tool for assembling a hose and a connector. The tool features a simple structure, including: a connector clamping assembly and a drive assembly configured to mechanically advance the connector toward the hose; and a hose clamping assembly configured to securely clamp tubular workpieces. Both the connector clamping assembly and the hose clamping assembly are adjustable to accommodate connectors and hoses of varying specifications, thereby improving operational efficiency and enhancing user experience.

The technical solution adopted by the present invention to solve the technical problem is as follows.

A tool for assembling a hose and a connector, which includes a base, a hose clamping assembly, a connector clamping assembly and a drive assembly.

The base includes an assembly axis α; the hose clamping assembly is slidably connected to the base; the connector clamping assembly is rotatably connected to the base and the drive assembly is configured to drive the connector clamping assembly to rotate about the assembly axis α while moving toward or away from the hose clamping assembly.

As an improvement of the present invention, the connector clamping assembly includes a clamping housing; the drive assembly includes a drive screw; the base includes a base threaded hole; the clamping housing is fixedly connected to the drive screw; the drive screw is rotatably connected to the base threaded hole; and when the drive screw rotates in the base threaded hole, the clamping housing drives the connector clamping assembly to rotate about the assembly axis α while moving toward or away from the hose clamping assembly.

As an improvement of the present invention, the connector clamping assembly further includes a first clamping jaw and a second clamping jaw; the clamping housing includes a fixed housing and a movable housing; the movable housing is lockably connected to the fixed housing; in an unlocked state of the movable housing, the first clamping jaw and the second clamping jaw are detachably mounted to the fixed housing and the movable housing; and in a locked state of the movable housing, the first clamping jaw and the second clamping jaw are configured to fix the connector.

As an improvement of the present invention, the first clamping jaw includes a first mounting portion; the second clamping jaw includes a second mounting portion; the fixed housing is provided with a first mounting slot; the movable housing is provided with a second mounting slot; the first mounting portion is engaged with the first mounting slot; the second mounting portion is engaged with the second mounting slot; each of the first mounting slot and the second mounting slot is provided with an adjustment mechanism; and the adjustment mechanism is configured to adjust positions of the first clamping jaw and the second clamping jaw in the first mounting slot and the second mounting slot respectively.

As an improvement of the present invention, the adjustment mechanism includes a first adjustment element and a second adjustment element; an inner side of the first clamping jaw is provided with a first groove; the second clamping jaw is provided with a second groove; and the first groove and the second groove are configured to engage with opposing outer contours of the connector.

As an improvement of the present invention, the first adjustment element and the second adjustment element are disposed on the fixed housing and the movable housing, respectively; and when the movable housing is in the locked state, the first adjustment element and the second adjustment element are positioned symmetrically about the assembly axis α.

As an improvement of the present invention, the drive assembly further includes a drive handle; the drive handle is movably connected to the drive screw and configured to drive the drive screw to rotate.

As an improvement of the present invention, the drive screw includes a threaded drive portion and a handle mounting portion; the handle mounting portion is provided with a handle mounting hole; the drive handle includes a connection portion and grip-limiting portions; the grip-limiting portions are disposed at two ends of the connection portion; and the connection portion is movably connected to the handle mounting hole.

As an improvement of the present invention, the hose clamping assembly includes a third adjustment element, a first clamping element, and a second clamping element; the base includes a mounting guide rail; the mounting guide rail is disposed in a direction perpendicular to the assembly axis α; the first clamping element and the second clamping element are slidably connected to the mounting guide rail; and the third adjustment element is configured to adjust a spacing between the first clamping element and the second clamping element.

As an improvement of the present invention, the hose clamping assembly further includes a limiting element; the limiting element is disposed between the first clamping element and the second clamping element; and the limiting element is configured to restrict movement of the third adjustment element in a direction parallel to the mounting guide rail.

As an improvement of the present invention, the first clamping element includes a first threaded hole; the second clamping element includes a second threaded hole; the third adjustment element includes a first threaded portion and a second threaded portion; the first threaded portion is threadedly engaged with the first threaded hole; the second threaded portion is threadedly engaged with the second threaded hole; and the first threaded portion and the second threaded portion have opposite thread directions.

As an improvement of the present invention, the third adjustment element further includes a limiting annular groove; the limiting annular groove is disposed between the first threaded portion and the second threaded portion; the limiting element includes a connection end and a limiting end; the connection end is fixedly connected to the base; and the limiting end is engaged with a partial outer contour of the limiting annular groove.

As an improvement of the present invention, the third adjustment element further includes a control handle; the control handle is configured to control rotation of the third adjustment element, thereby moving the first clamping element and the second clamping element toward or away from each other.

As an improvement of the present invention, the first clamping element includes a third groove configured to engage with a partial outer contour of the hose; the second clamping element includes a fourth groove configured to engage with a partial outer contour of the hose; and each of the third groove and the fourth groove is provided with an anti-slip structure.

As an improvement of the present invention, the fixed housing includes a first connection portion; the movable housing includes a second connection portion; and the first connection portion and the second connection portion are rotatably connected to enable relative rotation between the fixed housing and the movable housing.

As an improvement of the present invention, the clamping housing further includes a connection pivot shaft; and the first connection portion and the second connection portion are rotatably connected via the connection pivot shaft to enable relative rotation between the fixed housing and the movable housing.

As an improvement of the present invention, the clamping housing further includes a locking shaft; the movable housing includes a locking groove; and the locking shaft cooperates with the locking groove to switch the movable housing between a locked state and an unlocked state.

As an improvement of the present invention, the locking shaft includes a locking shaft segment and an unlocking shaft segment; the locking groove engages with an outer contour of the locking shaft segment to restrict rotation of the movable housing relative to the fixed housing, thereby locking the movable housing; and the locking shaft is axially movable to align the locking groove with an outer contour of the unlocking shaft segment, thereby releasing rotation restriction of the movable housing relative to the fixed housing.

As an improvement of the present invention, the fixed housing is provided with a shaft mounting blind hole and a shaft mounting through hole; and the locking shaft is axially movably mounted in the shaft mounting blind hole and the shaft mounting through hole.

As an improvement of the present invention, the shaft mounting blind hole is provided with a spring; and the spring abuts against the locking shaft to apply an axial preload force to the locking shaft.

With the above configuration, during operation, the drive assembly drives the connector clamping assembly to perform rotational motion about the assembly axis α, while simultaneously moving axially toward or away from the hose clamping assembly, thereby achieving synchronized axial advancement of the connector during rotation. This “rotation+linear feed” compound motion significantly reduces assembly time and is particularly suitable for precision-demanding rapid assembly applications. Compared to conventional manual operation, the efficiency is effectively improved. With the assembly axis α as the reference, both the rotational and linear motions of the connector clamping assembly are precisely executed along the same axis, ensuring that the mating surfaces of the connector and the hose maintain minimal coaxiality error. This effectively prevents sealing failure or stress concentration caused by angular misalignment. The slidable connection design of the hose clamping assembly allows manual adjustment of clamping distance and force according to the diameter of the hose. Combined with the rotational feed of the connector, this ensures uniform axial pressure distribution, guarantees consistent compression at the connecting end of the hose, and enhances both sealing performance and mechanical strength of the joint, thereby further improving user experience.

### BRIEF DESCRIPTION OF DRAWINGS

In order to explain the technical solutions of the embodiments of the present invention more clearly, the following will briefly introduce the accompanying drawings used in the embodiments. The drawings in the following description are only some embodiments of the present invention. Those of ordinary skill in the art can obtain other drawings based on these drawings without creative work. In addition, the accompanying drawings are not drawn to a scale of 1:1, and the relative dimensions of the various elements are only shown as examples in the diagrams, not necessarily drawn to a true scale.

The present invention is further described below in detail in combination with the accompanying drawings and embodiments.

FIG. 1 is a first-angle overall view of a tool for assembling a hose and a connector according to the present disclosure;

FIG. 2 is a second-angle overall view of the tool for assembling a hose and a connector according to the present disclosure;

FIG. 3 is a first cross-sectional view of the tool for assembling a hose and a connector according to the present disclosure;

FIG. 4 is a second cross-sectional view of the tool for assembling a hose and a connector according to the present disclosure;

FIG. 5 is an enlarged view of an area circled as A in FIG. 4;

FIG. 6 is a partial cutaway view of the tool for assembling a hose and a connector taken along a plane perpendicular to the base 100 and passing through the assembly axis α according to the present disclosure;

FIG. 7 is a first exploded view of the tool for assembling a hose and a connector according to the present disclosure; and

FIG. 8 is a second exploded view of the tool for assembling a hose and a connector according to the present disclosure.

### DETAILED DESCRIPTION OF THE INVENTION

To make the aforementioned objectives, features, and advantages of the present invention more comprehensible, specific implementations of the present invention are described in detail below in conjunction with the accompanying drawings. In the following description, numerous specific details are set forth to provide a thorough understanding of the present invention. The present invention may, however, be embodied in many forms different from that described here. A person skilled in the art can make similar improvements without departing from the connotation of the present invention. Therefore, the present invention is not limited by the specific embodiments disclosed below.

In the description of the present invention, It is to be understood that, The terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, For purposes of convenience only of describing the present invention and simplifying the description, Rather than indicating or implying that the indicated device or element must have a particular orientation, be constructed and operated in a particular orientation, therefore, not to be construed as limiting the present invention.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present invention, “multiple” means two or more unless explicitly specified otherwise.

In addition, the terms “install”, “arrange”, “provide”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present invention can be understood based on specific circumstances.

In the present invention, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

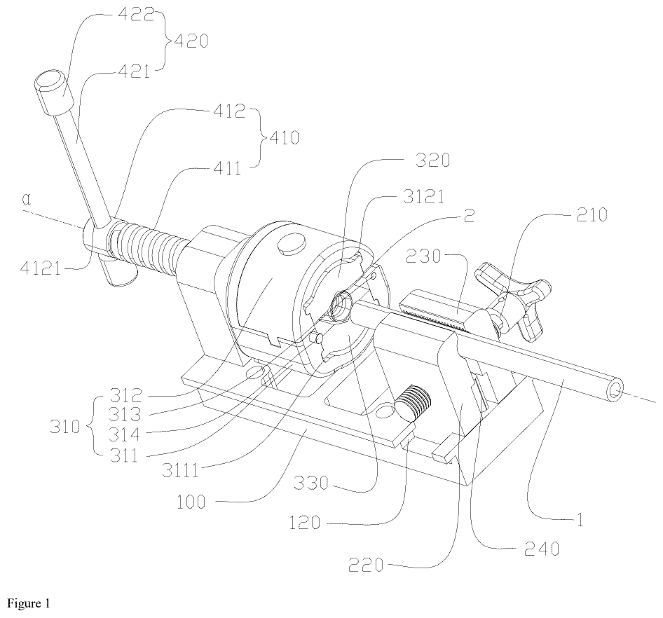

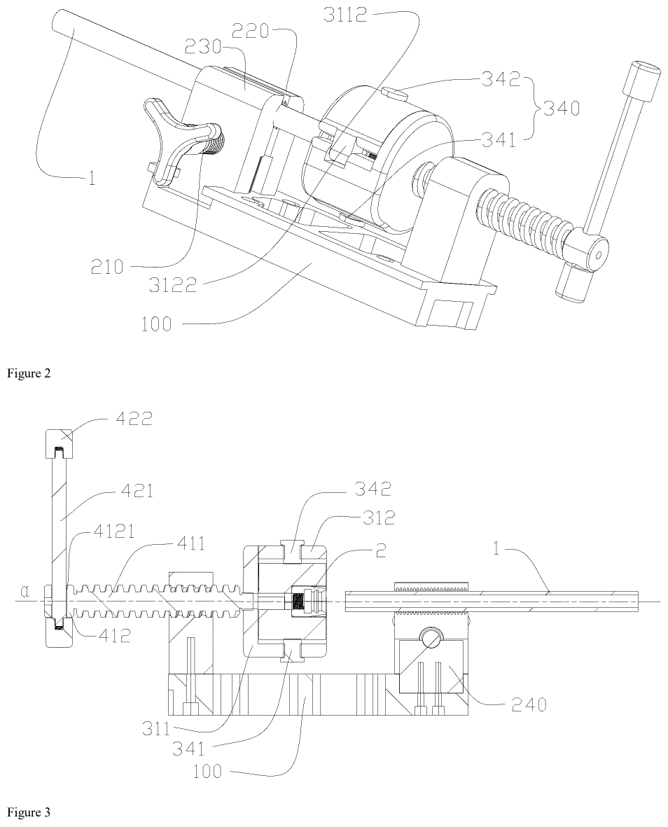

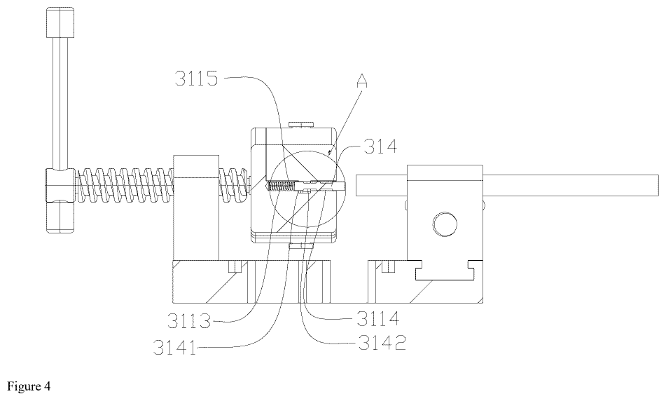

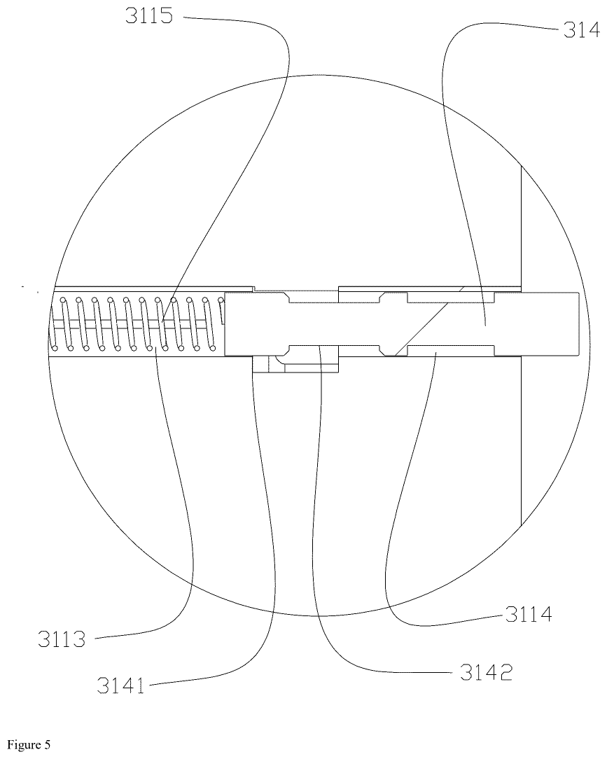

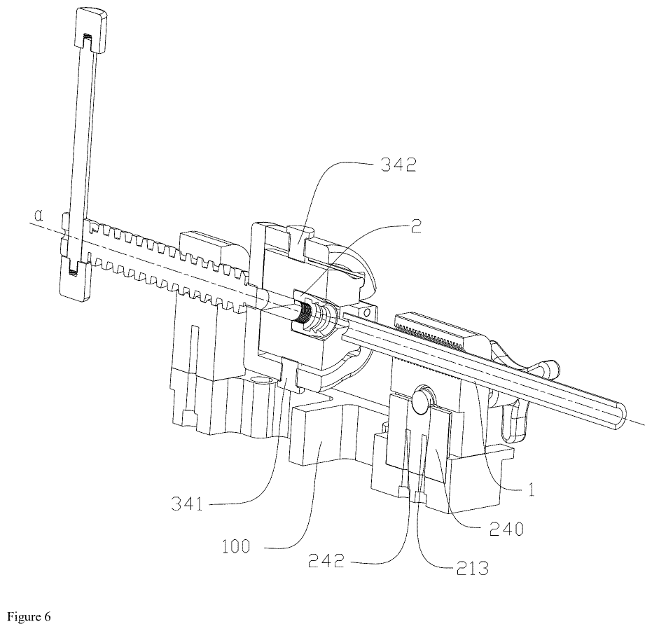

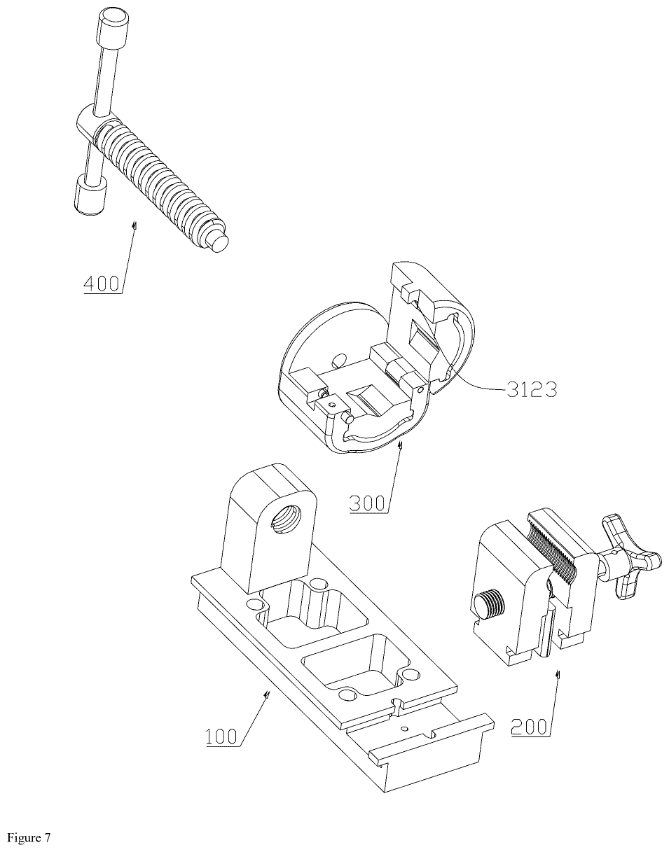

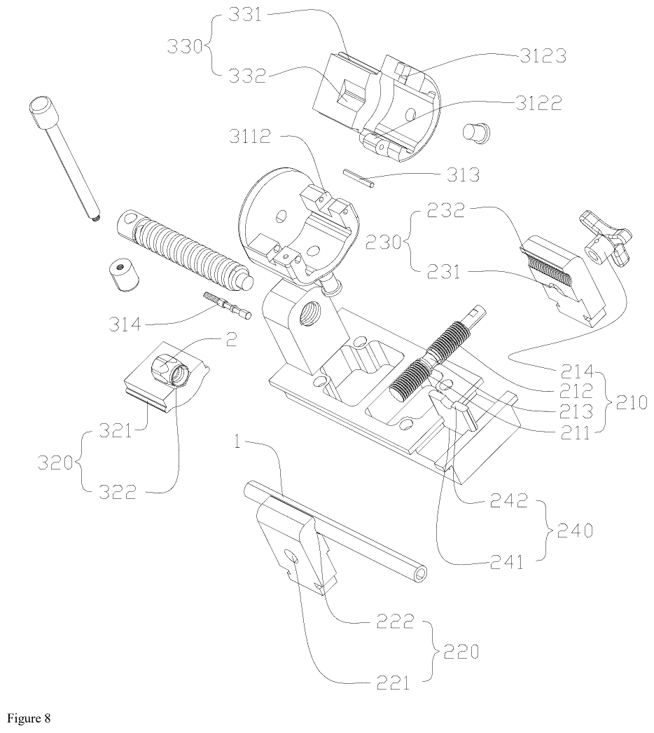

Referring to FIGS. 1 to 8, a tool for assembling a hose 1 and a connector 2 includes:
a base 100 including an assembly axis α;
a hose clamping assembly 200 slidably connected to the base 100;
a connector clamping assembly 300 rotatably connected to the base 100;
a drive assembly 400 configured to drive the connector clamping assembly 300 to rotate about the assembly axis α while moving toward or away from the hose clamping assembly 200.

With the above configuration, during operation, the drive assembly 400 drives the connector clamping assembly 300 to perform rotational motion about the assembly axis α, while simultaneously moving axially toward or away from the hose clamping assembly 200, thereby achieving synchronized axial advancement of the connector 2 during rotation. This “rotation +linear feed” compound motion significantly reduces assembly time and is particularly suitable for precision-demanding rapid assembly applications. Compared to conventional manual operation, the efficiency is effectively improved. With the assembly axis α as the reference, both the rotational and linear motions of the connector clamping assembly 300 are precisely executed along the same axis, ensuring that the mating surfaces of the connector 2 and the hose 1 maintain minimal coaxiality error. This effectively prevents sealing failure or stress concentration caused by angular misalignment. The slidable connection design of the hose clamping assembly 200 allows manual adjustment of clamping distance and force according to the diameter of the hose 1. Combined with the rotational feed of the connector 2, this ensures uniform axial pressure distribution, guarantees consistent compression at the connecting end of the hose 1, and enhances both sealing performance and mechanical strength of the joint, thereby further improving user experience.

In this embodiment, the connector clamping assembly 300 includes a clamping housing 310; the drive assembly 400 includes a drive screw 410; the base 100 includes a base threaded hole 110; the clamping housing 310 is fixedly connected to the drive screw 410; the drive screw 410 is rotatably connected to the base threaded hole 110; and when the drive screw 410 rotates in the base threaded hole 110, the clamping housing 310 drives the connector clamping assembly 300 to rotate about the assembly axis α while moving toward or away from the hose clamping assembly 200. With the above configuration, during operation, when the drive screw 410 rotates forwardly, the clamping housing 310 drives the connector clamping assembly 300 to rotate about the assembly axis α while concurrently axially advancing toward the hose clamping assembly 200 until the hose 1 and connector 2 are fully assembled. This structure achieves thread-driven rotational engagement between the connector and the hose 1. Rotation of the drive screw 410 in the base threaded hole 110 induces concurrent axial translation and rotation of the clamping housing 310 fixed thereto, driving the connector 2 to perform a simultaneous axial rotate-and-advance action. This design integrates linear and rotational motions into a single drive source, thereby simplifying the mechanism; the self-locking property of the threaded pair ensures connection stability, making it suitable for fluid-line quick connectors requiring anti-loosening and enhancing assembly efficiency and reliability. Notably, the base threaded hole 110 is a through hole, and the drive screw 410 extends through the base threaded hole 110 before being rigidly connected to the clamping housing 310.

In this embodiment, the connector clamping assembly 300 also includes a first clamping jaw 320 and a second clamping jaw 330; the clamping housing 310 includes a fixed housing 311 and a movable housing 312; the movable housing 312 is lockably connected to the fixed housing 311; in an unlocked state of the movable housing 312, the first clamping jaw 320 and the second clamping jaw 330 are detachably mounted to the fixed housing 311 and the movable housing 312; and in a locked state of the movable housing 312, the first clamping jaw 320 and the second clamping jaw 330 are configured to fix the connector 2. With the above configuration, during operation, when the movable housing 312 is unlocked, the first clamping jaw 320 and the second clamping jaw 330 are separable, facilitating replacement of the connector 2 with varying specifications or maintenance operations. Upon locking the movable housing 312, the first clamping jaw 320 and the second clamping jaw 330 form an enclosing configuration that secures the connector 2 by mechanical locking force. This modular design of the clamping jaws enhances adaptability while simultaneously utilizing mechanical locking to ensure reliable connection between the connector 2 and the hose 1.

In this embodiment, the first clamping jaw 320 includes a first mounting portion 321; the second clamping jaw 330 includes a second mounting portion 331; the fixed housing 311 is provided with a first mounting slot 3111; the movable housing 312 is provided with a second mounting slot 3121; the first mounting portion 321 is engaged with the first mounting slot 3111; the second mounting portion 331 is engaged with the second mounting slot 3121; each of the first mounting slot 3111 and the second mounting slot 3121 is provided with an adjustment mechanism 340; and the adjustment mechanism 340 is configured to adjust positions of the first clamping jaw 320 and the second clamping jaw 330 in the first mounting slot 3111 and the second mounting slot 3121 respectively. With the above configuration, during operation, the adjustment mechanism 340 compensates for machining tolerances to align the connector 2 clamped by the first clamping jaw 320 and the second clamping jaw 330 with the assembly axis α, thereby enhancing coaxial alignment precision. Engagement between the first mounting portion 321 and the first mounting slot 3111, and between the second mounting portion 331 and the second mounting slot 3121, ensures circumferential positioning accuracy, preventing rotation of the clamping jaws relative to the clamping housing 310 during operation.

In this embodiment, the adjustment mechanism 340 includes a first adjustment element 341 and a second adjustment element 342; an inner side of the first clamping jaw 320 is provided with a first groove 322; the second clamping jaw 330 is provided with a second groove 332; and the first groove 322 and the second groove 332 are configured to engage with opposing outer contours of the connector 2. With the above configuration, during operation, the first adjustment element 341 and the second adjustment element 342 (both of which are screws in this embodiment) independently adjust the positions of the clamping jaws to compensate for machining tolerances, ensuring precise alignment with the assembly axis α. The first groove 322 and the second groove 332 (both of which are V-shaped grooves in this embodiment) mate with the external contour of the connector 2 (which includes a hexagonal cross-section region in this embodiment), thereby maximizing contact area and enhancing clamping stability.

In this embodiment, the first adjustment element 341 and the second adjustment element 342 are disposed on the fixed housing 311 and the movable housing 312 respectively; and when the movable housing 312 is in the locked state, the first adjustment element 341 and the second adjustment element 342 are positioned symmetrically about the assembly axis α. With the above configuration, during operation, the first adjustment element 341 and the second adjustment element 342 ensure coaxial alignment and balanced clamping of the connector 2 via a symmetric adjustment mechanism. Upon locking the movable housing 312, the dual adjustment elements establish mirror-image constraints that center the first clamping jaw 320 and the second clamping jaw 330 relative to the assembly axis α, thereby preventing connection defects induced by unilateral stress concentration. The symmetrically arranged first adjustment element 341 and second adjustment element 342 generate balanced radial forces against the connector 2 when locked, counteracting eccentricity errors.

In this embodiment, the drive assembly 400 also includes a drive handle 420; the drive handle 420 is movably connected to the drive screw 410 and is configured to drive the drive screw 410 to rotate. With the above configuration, during operation, the drive handle 420 is movably connected to the drive screw 410, providing an ergonomic rotational force application point that reduces operator fatigue. Operatively, the drive handle 420 drives rotation of the drive screw 410 in the base threaded hole 110, converting manual input into simultaneous rotation and axial translation of the connector clamping assembly 300. This integrated motion enables engagement or disengagement between the connector 2 and the hose 1.

In this embodiment, the drive screw 410 includes a threaded drive portion 411 and a handle mounting portion 412; the handle mounting portion 412 is provided with a handle mounting hole 4121; the drive handle 420 includes a connection portion 421 and grip-limiting portions 422; the grip-limiting portions 422 are disposed at two ends of the connection portion 421; and the connection portion 421 is movably connected to the handle mounting hole 4121. With the above configuration, during operation, the operative movable connection between the handle mounting portion 412 and the connection portion 421 transmits rotational motion from the drive handle 420 to the drive screw 410 via the handle mounting hole 4121, enabling manual control over engagement or disengagement of the connector 2. Concurrently, the grip-limiting portions 422 prevent slippage of the drive handle 420 during operation, thereby enhancing operational safety.

In this embodiment, the hose clamping assembly 200 includes a third adjustment element 210, a first clamping element 220, and a second clamping element 230; the base 100 includes a mounting guide rail 120; the mounting guide rail 120 is disposed in a direction perpendicular to the assembly axis α; the first clamping element 220 and the second clamping element 230 are slidably connected to the mounting guide rail 120; and the third adjustment element 210 is configured to adjust a spacing between the first clamping element 220 and the second clamping element 230. With the above configuration, during operation, the mounting guide rail 120 provides linear guidance for the hose clamping assembly 200. The third adjustment element 210 drives the first clamping element 220 and the second clamping element 230 in reciprocating movement toward or away from each other, enabling self-adjusting clamping or releasing of hoses 1 with varying diameters. This configuration ensures coaxial alignment between the hose 1 and the connector 2.

In this embodiment, the hose clamping assembly 200 also includes a limiting element 240; the limiting element 240 is disposed between the first clamping element 220 and the second clamping element 230; and the limiting element 240 is configured to restrict movement of the third adjustment element 210 in a direction parallel to the mounting guide rail 120. With the above configuration, during operation, the limiting element 240 restricts axial displacement of the third adjustment element 210, preventing lateral displacement along the mounting guide rail 120. This axial constraint ensures adjustment forces act solely on clamping or unclamping operations of the first clamping element 220 and the second clamping element 230, thereby eliminating uneven clamping forces or hose eccentricity caused by misalignment of the third adjustment element 210. Consequently, clamping stability and coaxial precision are enhanced.

In this embodiment, the first clamping element 220 includes a first threaded hole 221; the second clamping element 230 includes a second threaded hole 231; the third adjustment element 210 includes a first threaded portion 211 and a second threaded portion 212; the first threaded portion 211 is threadedly engaged with the first threaded hole 221; the second threaded portion 212 is threadedly engaged with the second threaded hole 231; and the first threaded portion 211 and the second threaded portion 212 have opposite thread directions. With the above configuration, during operation, the hose clamping assembly 200 achieves synchronized self-centering of the first clamping element 220 and second clamping element 230 via opposite thread directions. Upon rotation of the third adjustment element 210, the first threaded portion 211 and the second threaded portion 212 with opposite thread directions drive synchronous movement of the first clamping element 220 and second clamping element 230 toward or away from each other along the mounting guide rail. This motion automatically centers the assembly axis α, ensuring the hose 1 remains coaxial with the connector 2 during clamping, thereby enhancing engagement precision.

In this embodiment, the third adjustment element 210 also includes a limiting annular groove 213; the limiting annular groove 213 is disposed between the first threaded portion 211 and the second threaded portion 212; the limiting element 240 includes a connection end 241 and a limiting end 242; the connection end 241 is fixedly connected to the base 100; and the limiting end 242 is engaged with a partial outer contour of the limiting annular groove 213. With the above configuration, during operation, the engagement between the limiting annular groove 213 and the limiting element 240 achieves axial constraint and rotational guidance of the third adjustment element 210. The limiting end 242 engages the limiting annular groove 213, allowing the third adjustment element 210 to rotate freely about its longitudinal axis to drive the first clamping element 220 and the second clamping element 230 to open or close, while restricting axial movement of the third adjustment element 210 to ensure stability of the threaded transmission, prevent unwanted axial movement during adjustment, and improve coaxial accuracy in clamping the hose 1.

In this embodiment, the third adjustment element 210 also includes a control handle 214; the control handle 214 is configured to control rotation of the third adjustment element 210, thereby moving the first clamping element 220 and the second clamping element 230 toward or away from each other. With the above configuration, during operation, the control handle 214 amplifies the applied torque via lever principle, enabling an operator to rotate the third adjustment element 210 to drive the first clamping element 220 and the second clamping element 230, thereby achieving synchronized opening and closing of the first clamping element 220 and the second clamping element 230. This design converts rotational motion into linear displacement, facilitating manual adjustment of the clamping jaw spacing to accommodate varying diameters of hoses 1, while utilizing the self-locking property of the threaded pair to maintain clamping force. This enhances operational convenience and clamping stability.

In this embodiment, the first clamping element 220 includes a third groove 222 configured to engage with a partial outer contour of the hose 1; the second clamping element 230 includes a fourth groove 232 configured to engage with a partial outer contour of the hose 1; and each of the third groove 222 and the fourth groove 232 is provided with an anti-slip structure. With the above configuration, during operation, the third groove 222 and the fourth groove 232 in conjunction with the anti-slip structure design achieve stable clamping of the hose 1: the third groove 222 and fourth groove 232 conform to the outer contour of the hose 1 to provide circumferential constraint and ensure the axis of the hose 1 coincides with the assembly axis α, while the anti-slip structure (such as serrations or rubber layers) is configured to increase frictional force to prevent slippage of the hose 1 during operation and enhance connection reliability.

In this embodiment, the fixed housing 311 includes a first connection portion 3112; the movable housing 312 includes a second connection portion 3122; and the first connection portion 3112 and second connection portion 3122 are rotatably connected to enable relative rotation between the fixed housing 311 and movable housing 312. With the above configuration, during operation, rotation of the movable housing 312 relative to the fixed housing 311 allows unlocking or locking, facilitating quick installation or removal of clamping jaws or replacement of connector 2 to enhance operational efficiency. Simultaneously, the first connection portion 3112 and second connection portion 3122 constrain a movement trajectory of the movable housing 312, thereby ensuring centering of the clamping jaws on the assembly axis α during locking and avoiding clamping failure caused by misalignment. The pivotal connection stably transmits clamping forces to form a reliable mechanical constraint, making it suitable for scenarios requiring frequent assembly or disassembly.

In this embodiment, the clamping housing 310 also includes a connection pivot shaft 313; and the first connection portion 3112 and the second connection portion 3122 are rotatably connected via the connection pivot shaft 313 to enable relative rotation between the fixed housing 311 and the movable housing 312. With the above configuration, during operation, the connection pivot shaft 313 functions as a pivot point, thereby forming a pivotal connection that enables relative rotation between the fixed housing 311 and the movable housing 312.

In this embodiment, the clamping housing 310 also includes a locking shaft 314; the movable housing 312 includes a locking groove 3123; and the locking shaft 314 cooperates with the locking groove 3123 to switch the movable housing 312 between a locked state and an unlocked state. With the above configuration, during operation, the clamping housing 310 achieves rapid locking or unlocking of the first clamping element 220 and the second clamping element 230 through cooperative engagement between the locking shaft 314 and locking groove 3123. When the locking shaft 314 engages with the locking groove 3123, rotational freedom of the movable housing 312 is restricted, maintaining the movable housing 312 in a closed state to provide stable clamping force.

In this embodiment, the locking shaft 314 includes a locking shaft segment 3141 and an unlocking shaft segment 3142; the locking groove 3123 engages with an outer contour of the locking shaft segment 3141 to restrict rotation of the movable housing 312 relative to the fixed housing 311, thereby locking the movable housing 312; and the locking shaft 314 is axially movable to align the locking groove 3123 with an outer contour of the unlocking shaft segment 3142, thereby releasing rotation restriction of the movable housing 312 relative to the fixed housing 311. With the above configuration, during operation, the locking shaft 314 employs a stepped shaft configuration to enable dual-state switching of the movable housing 312 relative to the fixed housing 311. When the locking shaft segment 3141 engages the locking groove 3123, its cylindrical contour restricts rotation of the movable housing 312 about the connection pivot shaft 313, forming a rigid constraint that ensures stable clamping force from the first clamping element 220 and second clamping element 230. Axial displacement of the locking shaft 314 aligns the smaller-diameter unlocking shaft segment 3142 with the locking groove 3123, permitting rotational freedom of the movable housing 312 for rapid opening of the clamping elements. The abrupt diameter change between shaft segments provides tactile position feedback, preventing intermediate locking positions and delivering a simplified yet reliable locking solution for quick change clamping mechanisms.

In this embodiment, the fixed housing 311 is provided with a shaft mounting blind hole 3113 and a shaft mounting through hole 3114; and the locking shaft 314 is axially movably mounted in the shaft mounting blind hole 3113 and the shaft mounting through hole 3114. With the above configuration, during operation, the shaft mounting blind hole 3113 and the shaft mounting through hole 3114 collectively provide guidance and positional restraint for the locking shaft 314. The coaxial alignment of the shaft mounting blind hole 3113 and the shaft mounting through hole 3114 ensures precise alignment required for full engagement between the locking shaft 314 and the locking groove 3123 of the movable housing 312, thereby enhancing locking reliability.

In this embodiment, the shaft mounting blind hole 3113 is provided with a spring 3115; and the spring 3115 abuts against the locking shaft 314 to apply an axial preload force to the locking shaft 314. With the above configuration, during operation, the spring 3115 maintains the locking shaft segment 3141 in engagement with the locking groove 3123 under no external force, securely maintaining the movable housing 312 in a locked state without requiring additional actuation force and streamlining operation. Simultaneously, the spring force counteracts external impacts (e.g., vibrations) applied to the locking shaft 314, preventing unintended unlocking due to axial displacement and enhancing mechanism reliability.

As described above, one or more embodiments are provided in conjunction with the detailed description, The specific implementation of the present invention is not confirmed to be limited to that the description is similar to or similar to the method, the structure and the like of the present invention, or a plurality of technical deductions or substitutions are made on the premise of the conception of the present invention to be regarded as the protection of the present invention.

1. A tool for assembling a hose and a connector, comprising:
a base comprising an assembly axis α;
a hose clamping assembly slidably connected to the base;
a connector clamping assembly rotatably connected to the base;
a drive assembly configured to drive the connector clamping assembly to rotate about the assembly axis α while moving toward or away from the hose clamping assembly.

2. The tool for assembling a hose and a connector according to claim 1, wherein the connector clamping assembly comprises a clamping housing; the drive assembly comprises a drive screw; the base comprises a base threaded hole; the clamping housing is fixedly connected to the drive screw; the drive screw is rotatably connected to the base threaded hole; and when the drive screw rotates in the base threaded hole, the clamping housing drives the connector clamping assembly to rotate about the assembly axis α while moving toward or away from the hose clamping assembly.

3. The tool for assembling a hose and a connector according to claim 2, wherein the connector clamping assembly further comprises a first clamping jaw and a second clamping jaw; the clamping housing comprises a fixed housing and a movable housing; the movable housing is lockably connected to the fixed housing; in an unlocked state of the movable housing, the first clamping jaw and the second clamping jaw are detachably mounted to the fixed housing and the movable housing; and in a locked state of the movable housing, the first clamping jaw and the second clamping jaw are configured to fix the connector.

4. The tool for assembling a hose and a connector according to claim 3, wherein the first clamping jaw comprises a first mounting portion; the second clamping jaw comprises a second mounting portion; the fixed housing is provided with a first mounting slot; the movable housing is provided with a second mounting slot; the first mounting portion is engaged with the first mounting slot; the second mounting portion is engaged with the second mounting slot; each of the first mounting slot and the second mounting slot is provided with an adjustment mechanism; and the adjustment mechanism is configured to adjust positions of the first clamping jaw and the second clamping jaw in the first mounting slot and the second mounting slot respectively.

5. The tool for assembling a hose and a connector according to claim 4, wherein the adjustment mechanism comprises a first adjustment element and a second adjustment element; an inner side of the first clamping jaw is provided with a first groove; the second clamping jaw is provided with a second groove; and the first groove and the second groove are configured to engage with opposing outer contours of the connector.

6. The tool for assembling a hose and a connector according to claim 5, wherein the first adjustment element and the second adjustment element are disposed on the fixed housing and the movable housing, respectively; and when the movable housing is in the locked state, the first adjustment element and the second adjustment element are positioned symmetrically about the assembly axis α.

7. The tool for assembling a hose and a connector according to claim 2, wherein the drive assembly further comprises a drive handle; the drive handle is movably connected to the drive screw and configured to drive the drive screw to rotate.

8. The tool for assembling a hose and a connector according to claim 2, wherein the drive screw comprises a threaded drive portion and a handle mounting portion; the handle mounting portion is provided with a handle mounting hole; the drive handle comprises a connection portion and grip-limiting portions; the grip-limiting portions are disposed at two ends of the connection portion; and the connection portion is movably connected to the handle mounting hole.

9. The tool for assembling a hose and a connector according to claim 1, wherein the hose clamping assembly comprises a third adjustment element, a first clamping element, and a second clamping element; the base comprises a mounting guide rail; the mounting guide rail is disposed in a direction perpendicular to the assembly axis α; the first clamping element and the second clamping element are slidably connected to the mounting guide rail; and the third adjustment element is configured to adjust a spacing between the first clamping element and the second clamping element.

10. The tool for assembling a hose and a connector according to claim 9, wherein the hose clamping assembly further comprises a limiting element; the limiting element is disposed between the first clamping element and the second clamping element; and the limiting element is configured to restrict movement of the third adjustment element in a direction parallel to the mounting guide rail.

11. The tool for assembling a hose and a connector according to claim 10, wherein the first clamping element comprises a first threaded hole; the second clamping element comprises a second threaded hole; the third adjustment element comprises a first threaded portion and a second threaded portion; the first threaded portion is threadedly engaged with the first threaded hole; the second threaded portion is threadedly engaged with the second threaded hole; and the first threaded portion and the second threaded portion have opposite thread directions.

12. The tool for assembling a hose and a connector according to claim 11, wherein the third adjustment element further comprises a limiting annular groove; the limiting annular groove is disposed between the first threaded portion and the second threaded portion; the limiting element comprises a connection end and a limiting end; the connection end is fixedly connected to the base; and the limiting end is engaged with a partial outer contour of the limiting annular groove.

13. The tool for assembling a hose and a connector according to claim 12, wherein the third adjustment element further comprises a control handle; the control handle is configured to control rotation of the third adjustment element, thereby moving the first clamping element and the second clamping element toward or away from each other.

14. The tool for assembling a hose and a connector according to claim 9, wherein the first clamping element comprises a third groove configured to engage with a partial outer contour of the hose; the second clamping element comprises a fourth groove configured to engage with a partial outer contour of the hose; and each of the third groove and the fourth groove is provided with an anti-slip structure.

15. The tool for assembling a hose and a connector according to claim 3, wherein the fixed housing comprises a first connection portion; the movable housing comprises a second connection portion; and the first connection portion and the second connection portion are rotatably connected to enable relative rotation between the fixed housing and the movable housing.

16. The tool for assembling a hose and a connector according to claim 3, wherein the clamping housing further comprises a connection pivot shaft; and the first connection portion and the second connection portion are rotatably connected via the connection pivot shaft to enable relative rotation between the fixed housing and the movable housing.

17. The tool for assembling a hose and a connector according to claim 3, wherein the clamping housing further comprises a locking shaft; the movable housing comprises a locking groove; and the locking shaft cooperates with the locking groove to switch the movable housing between a locked state and an unlocked state.

18. The tool for assembling a hose and a connector according to claim 17, wherein the locking shaft comprises a locking shaft segment and an unlocking shaft segment; the locking groove engages with an outer contour of the locking shaft segment to restrict rotation of the movable housing relative to the fixed housing, thereby locking the movable housing; and the locking shaft is axially movable to align the locking groove with an outer contour of the unlocking shaft segment, thereby releasing rotation restriction of the movable housing relative to the fixed housing.

19. The tool for assembling a hose and a connector according to claim 17, wherein the fixed housing is provided with a shaft mounting blind hole and a shaft mounting through hole; and the locking shaft is axially movably mounted in the shaft mounting blind hole and the shaft mounting through hole.

20. The tool for assembling a hose and a connector according to claim 19, wherein the shaft mounting blind hole is provided with a spring; and the spring abuts against the locking shaft to apply an axial preload force to the locking shaft.
